(19) United States
(12) Patent Application Publication
(10) Pub. No.: US 2008/0283200 A1
(43) Pub. Date: Nov. 20, 2008

(54) CLUTCH FOR INSULATED GLASS WINDOW COVERING

(75) Inventors: Benjamin P. Hummel, Cedar Springs, MI (US); Allen C. Ouzts, Holland, MI (US); Joshua R. Cornish, Holland, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: ODL, INCORPORATED, Zeeland, MI (US)

(21) Appl. No.: 11/748,276

(22) Filed: May 14, 2007

(51) Int. Cl. E06B 9/264

(52) U.S. Cl. 160/107; 160/90

(57) ABSTRACT

An insulated glass (IG) internal blind assembly including a clutch for providing directional friction when raising and lowering the blind. The clutch is directionally activated, the gravitational pull of the blinds or lowering the blinds activates the clutch causing it to lock and add friction to the system. The clutch may be placed essentially anywhere along the cord path where the path changes direction. Various clutch and cord configurations may be used to achieve a desired amount of directional friction. The directional friction prevents the window covering from falling under its own weight.

### BACKGROUND OF THE INVENTION

The present invention relates to window coverings, and more particularly to window coverings contained within insulated glass.

Insulated glass window assemblies with internal window coverings are well known. The insulated glass includes two spaced glass panels sealed to a spacer frame to define a space between the panels. A window covering, such as a blind or shade, is positioned within the space and is operable using operators on the outside of the insulated glass that are magnetically coupled through the glass to the blind assembly. An example of such a construction is illustrated in U.S. Pat. No. 6,932,139 filed Aug. 6, 2003 by Early et al, the disclosure of which is incorporated by reference.

In one implementation of an IG internal blind assembly, the blinds are raised and lowered using an external operator that is magnetically coupled to an internal follower. One end of a blind pull cord attaches to the follower and the other end attaches to the blinds. A user may raise or lower the blinds by sliding the operator which moves the follower and in turn the blinds.

Unfortunately, because of the amount of friction, a relatively large amount of operator effort is required to raise and lower the blinds. This problem is compounded by reduced operator travel mechanisms employed in some IG internal blind assemblies. These mechanisms reduce the distance the operator travels relative to the blinds at the cost of increasing the operator effort it takes to raise and lower the blinds.

Low-friction bearings and other friction reducing mechanisms may be employed to reduce the amount of operator effort required to raise and lower the blinds. Although these mechanisms reduce the amount of operator effort needed to raise and lower the blinds, they also decrease the friction to the point where the blinds sometimes have trouble maintaining their position. In particular, heavier blinds in a fully raised position have a tendancy to fall under their own weight.

Therefore, a solution which assists in maintaining the blinds in position so that they do not fall under their own weight and that does not significantly increase operator effort is desired.

### SUMMARY OF THE INVENTION

The aforementioned problems are overcome in the present invention in which an IG blind assembly includes a clutch bearing to variably add friction to an IG internal blind or covering assembly. When the clutch is inactive the bearing is free-rolling which allows the blind pull cords to move freely around the bearing and reduce the amount of operator effort needed to raise the blinds. When the clutch is active, the bearing locks and the blind pull cords are held in position on the bearing. The friction between the blind pull cords and the locked bearing is sufficient to overcome the gravitational pull of the blinds. The clutch is directionally activated such that it is inactive while raising the blinds and activates under the gravitational pull of the blinds or while lowering the blinds.

The clutch bearing may be placed essentially anywhere along the cord path where the blind cord path changes direction. For example, the clutch bearing may be located at a tilt barrel, a corner key, a follower or essentially anywhere else a blind cord changes direction.

Various clutch and blind pull cord configurations may be used to achieve varying amounts of directional friction. For example, multiple clutch bearings, arranged in-line or offset, single or multiple blind pull cords, or multiple blind pull cord wraps may be used to implement a desired amount of friction. In another aspect of the invention, a ratcheting clutch wheel and paddle may replace the clutch bearing. The ratcheting clutch provides directional one-way rotation. The wheel rolls free in one direction as the paddle slides over the ratchet teeth and locks in the other direction as the paddle pushes against the ratchet teeth.

Use of a clutch in an IG internal blind assembly provides directional rolling and directional friction without additional input or action from a user. Upon raising the blinds, the clutch rotates as the cord passes over; and upon lowering the blinds, the blind cord drags across the clutch causing friction. The clutch essentially allows a reduction or increase in friction when it is appropriate. The benefits of reduced travel mechanisms may be recognized without the blinds falling under their own weight.

These and other objects, advantages, and features of the invention will be more fully understood and appreciated by reference to the description of the current embodiments and the drawings.

### BRIEF DESCRIPTION OF THE DRAWINGS

FIG. 1 is a front view of the IG internal blind assembly of the present invention.

FIG. 2 is a perspective exploded view of the IG internal blind assembly.

FIG. 3 is a perspective exploded view of a portion of the blind assembly.

FIG. 4 is a close-up perspective view of a tilt barrel.

FIG. 5 is a perspective exploded view of an in-line clutch bearing corner key.

FIG. 6 is a perspective view of the in-line clutch bearing corner key.

FIG. 7 is a sectional view of the in-line clutch bearing corner key taken along line 7-7 in FIG. 6.

FIG. 8 is a perspective view of a clutch bearing.

FIG. 9 is a side view of the clutch bearing.

FIG. 10 is a sectional view of the clutch bearing taken along line 10-10 in FIG. 9.

FIG. 11A is a front view showing a portion of the blind cords routing.

FIG. 11B is a perspective exploded view showing a portion of the blind cords routing.

FIG. 12 is a diagram showing the cord path of in-line clutch bearings.

FIG. 13 is a diagram showing the cord path of offset clutch bearings.

FIG. 14 is a diagram showing the cord path of a single clutch bearing.

FIG. 15 is a diagram showing the cord path of a multiple wrap single clutch bearing.

FIG. 16 is a diagram showing the cord path of a ratcheting clutch wheel and paddle.

### DESCRIPTION OF THE CURRENT EMBODIMENTS

An IG blind assembly with a clutch bearing is illustrated in the figures and generally designated 10. In the current embodiment, two in-line clutch bearing assemblies 80, 82 are integrated into one of the corner key assemblies 47. Blind pull cords 13 are attached at one end to the blinds 50 and routed through the clutch bearing assemblies 80, 82, through the follower 24 and attached to the intermediate pulley 26. As operator 25 is lowered, the follower 24 also lowers, pulling the blind pull cords 13 in the direction of the follower 24 through the free-rolling clutch bearing assemblies 80, 82, ultimately raising the blinds 50. As operator 25 is raised the follower 24 also raises, pulling the blind pull cords 13 in the the direction of the blinds 50 through the locked clutch bearing assemblies 80, 82, ultimately lowering the blinds 50. This is merely one embodiment of the invention, a person of ordinary skill in the art would understand how to implement alternative clutch and blind pull cord configurations.

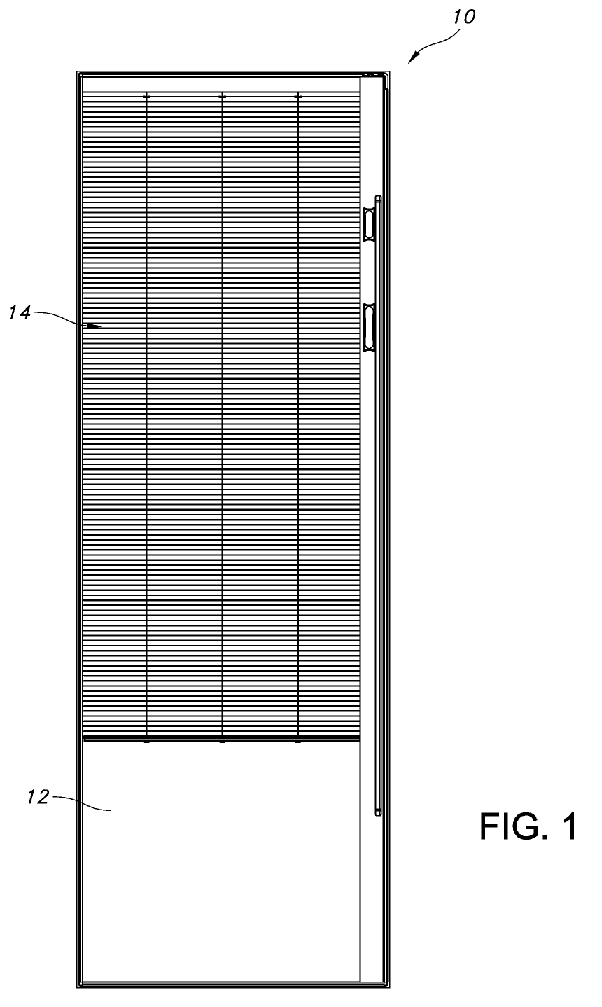

The IG blind assembly of the current embodiment is depicted in FIGS. 1-12. The IG blind assembly includes an insulated glass 12, a blind assembly 14, an operator system 100, and at least one clutch bearing assembly 80, 82. Alternative insulated glass, blind assemblies, and operator systems may be implemented instead of those described below and depicted in the figures. For example, in one alternative embodiment, the IG blind assembly may be implemented as an external, add-on blind unit. In another alternative embodiment, the operators may run horizontally instead of vertically. The clutch configuration of the current embodiment is just one example configuration, various alternative embodiments may be implemented, some of which will be described in more detail below.

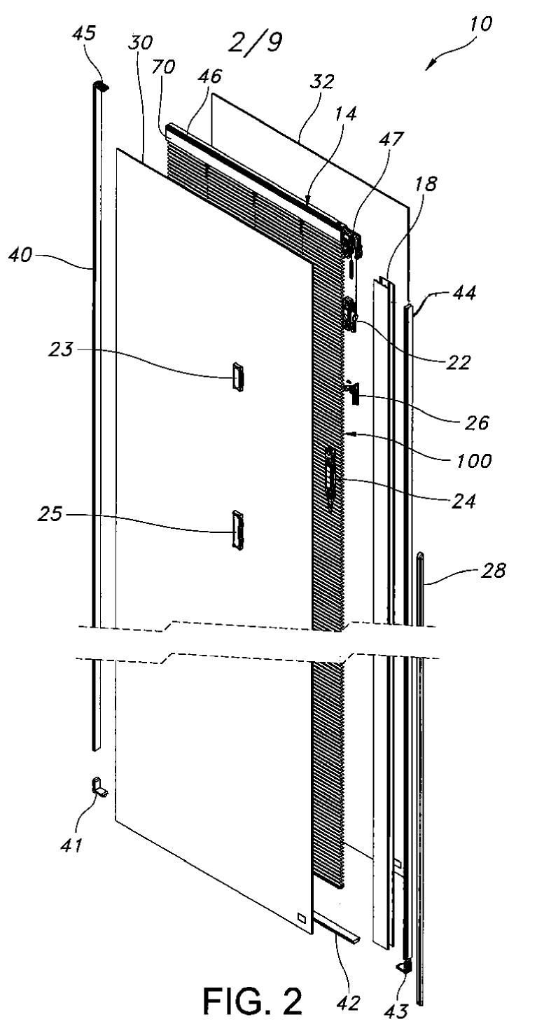

As perhaps best seen in FIG. 2, the insulated glass 12 includes two spaced glass panels 30, 32 sealed to a spacer frame 40-47 to define a space between the panels. The spacer frame is made up of various spacers 40, 42, 44, 46 and corner key assemblies 41, 43, 45, 47 that are known in the art. The insulated glass need not use spacers and corner keys, other suitable parts may be used to create the insulated glass.

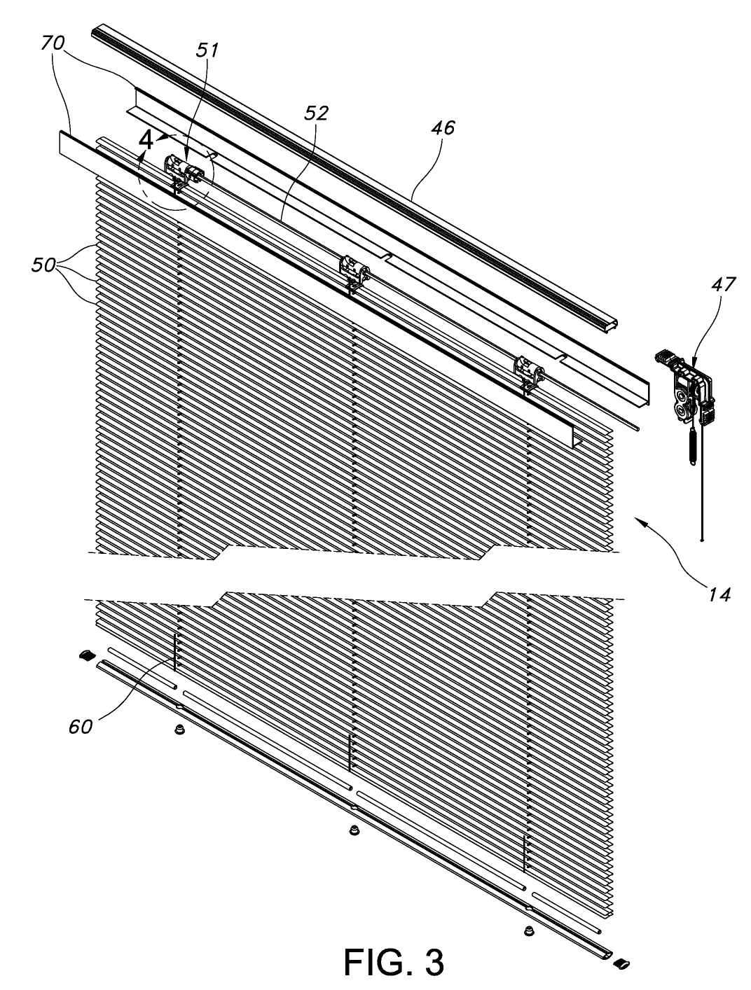

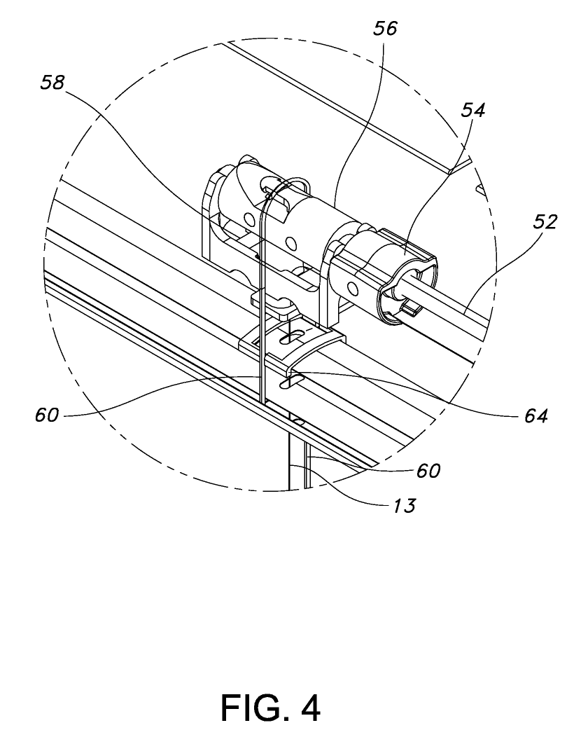

The blind assembly 14 of the current embodiment is depicted in FIG. 3. The blind assembly 14 includes blinds 50, three tilt barrel assemblies 51, and a tilt rod 52. The tilt rod 52 slides through each of the tilt barrel assemblies 51 and each of the tilt barrel assemblies 51 attaches to the blinds 50 with a blind clip 64, shown in FIG. 4. Optionally, a cover 70 hides the tilt rod 52 and the tilt barrel assemblies 51 from view. The blind assembly 14 is positioned within the space defined by the insulated glass 12 and is operable by operators 23, 25 which will be described in more detail below. As mentioned above, the blind assembly 14 is merely exemplary, essentially any blind assembly that is operated using a cord may be utilized.

Although the current embodiment is illustrated with blinds 50, any suitable window covering operated using a cord may be utilized, such as a shade. The blinds 50 include a plurality of tiltable slats that may be opened or closed by rotating the tilt rod 52 which in turn rotates the tilt barrels 56 of the tilt barrel assemblies 51 and their associated ladder cords 60. The configuration of the blind pull cords 13, ladder cords 60 and blinds 50 are well known and therefore will not be described in detail. Generally, the slats of the blinds 50 are connected with a ladder cord. Each of the ladder cords 60 are routed through a respective tilt barrel assembly 51. When the tilt rod 52 is rotated in one direction one side of the ladder cord 60 raises and the other side lowers causing the blinds to tilt. When the tilt rod 52 is rotated in the opposite direction the blinds are tilted in the reverse direction. A tilt stop 54 may be used to restrict how far the blind slats can be tilted.

The slats of the blinds 50 are also connected by the blind pull cords 13 which are weaved in between each of the slats. As the blind pull cords 13 are pulled toward the follower the blind slats raise and scrunch together against one another. In the current embodiment, the string baskets 58 of their respective tilt barrel assemblies 51 provide a bearing surface for the pull cords 13 as they change direction from vertical to horizontal. The number and amount of tilt cords 60 and blind pull cords 13 may vary depending on the desired length and width of the blinds.

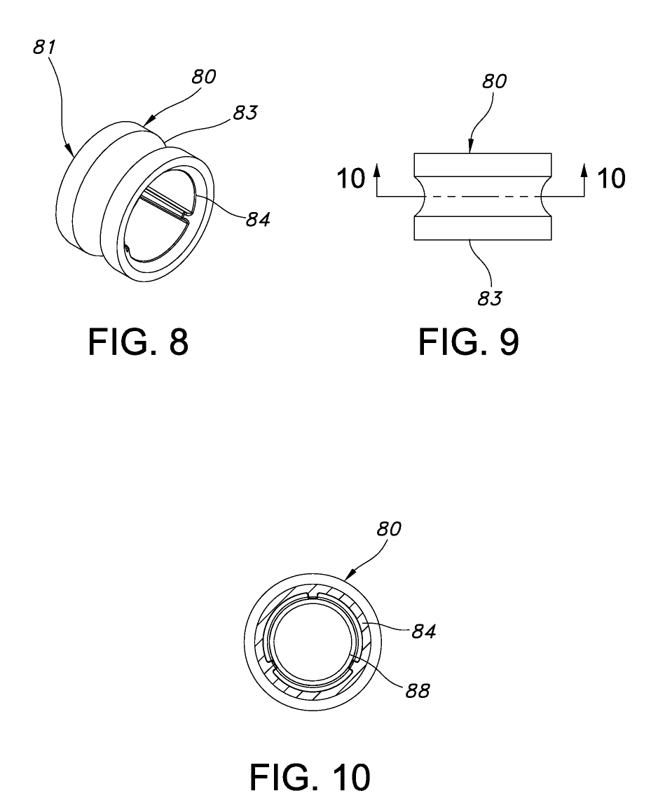

The clutch bearing assembly 80 of the current embodiment is depicted in FIGS. 8-10. The clutch bearing assembly 80 includes a pulley wheel 83, a clutch bearing 84, and a steel shaft 88. In the depicted embodiment, the steel shaft 88 includes a keyway 87 which interfits with the corner key assembly 47 to keep the shaft in place while the clutch bearing 84 and pulley wheel 83 rotate. In alternative embodiments, the keyway may be deleted and the shaft 88 may be rigidly secured to to the corner key or kept in place by another means known to one skilled in the art. The structure and operation of a clutch bearing assembly is well known in the art and will not be described in detail. The one-way clutch bearings presently utilized in the current embodiment are conventional off the shelf parts. Generally, the clutch bearing assembly 80 allows the bearing to roll free in one direction and locks the bearing in the other direction. Essentially this means that a cord pulled across the pulley wheel in one direction will slip freely without much friction. When the cord is pulled across the pulley wheel in the other direction, the bearing will drag against the pulley wheel causing friction. The amount of friction in both directions may be varied depending on the configuration and specifications of the clutch bearing assembly.

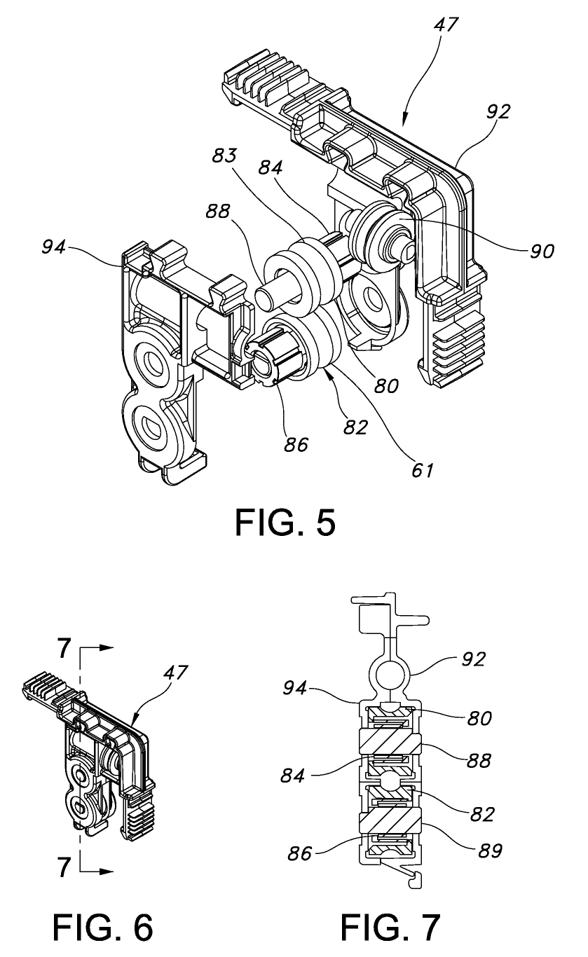

The corner key assembly 47 of the current embodiment is depicted in FIGS. 5-7. The corner key assembly 47 includes a corner key 92, a corner key cap 94, two clutch bearing assemblies 80, 82, and a tilt pulley 90. In the current embodiment, the second clutch bearing assembly 82 is similar to the first clutch bearing assembly 80, but oriented differently. The second clutch bearing assembly includes a clutch bearing 86 and a steel shaft 89 with a keyway. The corner key 92 and corner key cap 94 interfit to house the clutch bearing assemblies 80, 82 and the tilt pulley 90. In alternative embodiments, the corner key 92 and corner key cap 94 may be replaced by a single corner key to which the clutch bearings and tilt pulley may be housed, attached or otherwise connected. Although the clutch bearing assemblies 80, 82 are located at the corner key assembly 47 in the current embodiment, in alternative embodiments the clutch bearings may be located elsewhere along the blind pull cord path. In alternative embodiments, fewer or additional clutch bearings may be implemented in a variety of different configurations to achieve a desired amount of friction. The tilt pulley 90 is optional, in the current embodiment the tilt pulley 90 is conventional and allows for the tilting of the blinds 50.

The operator system 100 of the current embodiment is illustrated generally in FIG. 2. The operator system 100 includes a raise/lower operator 25, a tilt operator 23, a raise/lower follower 24, a tilt follower 22, intermediate pulley 26, and track 28. The structure and operation of an operator system is well known in the art and will not be described in detail. Generally, the operators 23, 25 are disposed outside of the insulated glass 12 and magnetically coupled to their respective followers 22, 24. The followers 22, 24 ride along the track 28. In the current embodiment, the followers are hidden from view by the cover 18.

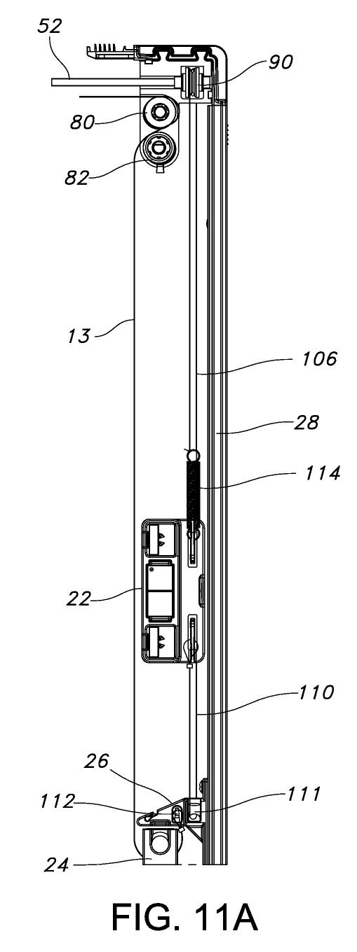

Generally, the tilt follower 22 is connected to the intermediate pulley 26 by the tilt tension cord 110, perhaps as best shown in FIG. 11A. The tilt follower 22 is connected to the tilt pulley 90 by the tilt cord 110 and the tilt tension spring 114. The raise/lower follower 24 is connected to the intermediate pulley 26 by the blind pull cords 13.

The path of the blind pull cords 13 of the current embodiment is shown in FIGS. 11A and 11B. As discussed above, the current embodiment includes three blind pull cords, but alternative embodiments may include a different number. In the current embodiment, the blind pull cords 13 are routed from the blinds 50 through the tilt barrels 51 to the clutch bearing assemblies 80, 82. From the clutch bearing assemblies 80, 82, the blind pull cords 13 are routed through the follower 24 and connect to the intermediate pulley 26. The blind pull cords 13 change direction at the tilt barrel assemblies, the corner key 47 and the follower 24. In alternative embodiments, the blind pull cords may be routed such that they change directions at additional locations. Although in the current embodiment, the clutch bearing assemblies 80, 82 are located only at the corner key assembly 47, in alternative embodiments, clutch bearing assemblies may be positioned essentially anywhere along the blind pull cord path where the path changes direction. In an alternative, full travel, embodiment, the pull cords attach directly to the follower.

In the current embodiment, the top clutch bearing assembly 80 is in a free-roll state when moving in a clockwise direction and a locked state when moving in a counter-clockwise direction. The bottom clutch bearing assembly 82 is in a locked state when moving in a clockwise direction and a free-roll state when moving in a counter-clockwise direction.

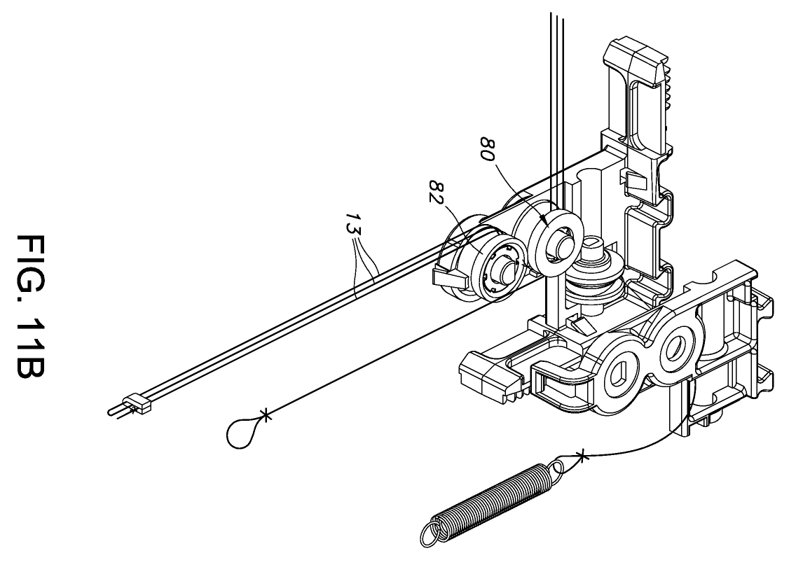

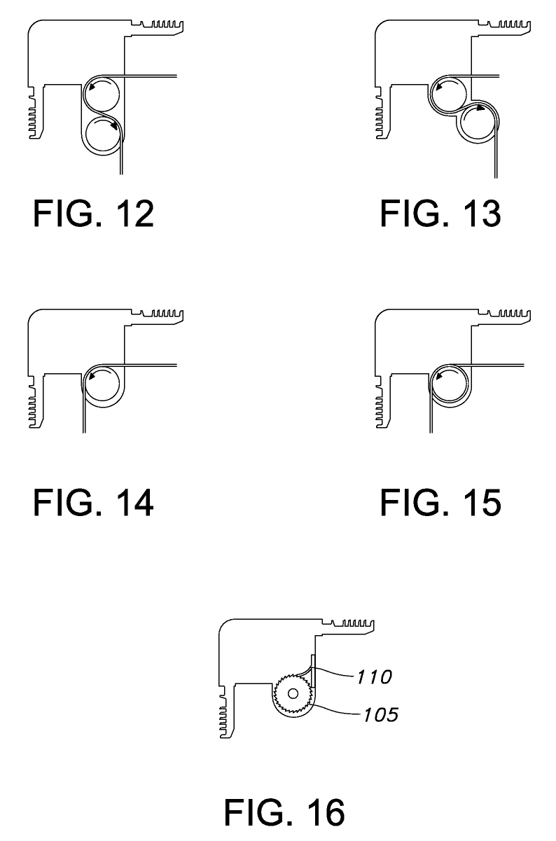

Various alternative embodiment clutch bearing assembly configurations are shown in FIGS. 12-15. The arrows indicate the direction of the free-roll state of the clutch bearing, the opposite direction of the arrow indicates a locked state of the clutch bearing. FIG. 12 illustrates an in-line two clutch bearing assembly configuration similar to the one of the current embodiment, except that the clutch bearing assemblies are associated with a different corner key-in this embodiment the top left corner key 45. FIG. 13 illustrates an offset two clutch bearing assembly configuration. FIG. 14 illustrates a single clutch bearing assembly configuration. FIG. 15 illustrates a multiple wrap clutch bearing assembly configuration.

A ratcheting clutch may be used in place of a clutch bearing. FIG. 16 illustrates a racheted clutch embodiment. The ratcheting wheel 105 is free to rotate in a counter clockwise direction, but the paddle 110 causes the wheel to lock if it is rotated in a clockwise direction. The ratcheting clutch is functionary similar to the clutch bearing described above.

These and other modifications and/or embodiments of the invention described herein will become apparent to the reader deemed to be one of ordinary skill in the art. Such modifications are contemplated to be inherent and within the scope of this description.

1. An insulated glass assembly comprising:
first and second glass panels;
a window covering between said first and second glass panels;
an operator system connected to said window covering and capable of operating said window covering, said operator system including a variable friction device providing a first amount of friction when moving in a first direction and a second amount of friction when moving in a second direction, said second amount being different from said first amount.

2. The insulated glass assembly of claim 1 further comprising an additional variable friction device, wherein said additional variable friction device provides a third amount of friction when moving in said first direction and a fourth amount of friction when moving in said second direction.

3. The insulated glass assembly of claim 1 wherein said window covering is selected from at least one of a shade and a blind.

4. The insulated glass assembly of claim 1 wherein said window covering comprises a tilt barrel and wherein said operator system comprises a follower and a cord, wherein said cord is routed through said tilt barrel, said variable friction device, and said follower.

5. The insulated glass assembly of claim 4 wherein said cord changes direction at said tilt barrel, said follower and a corner key of a spacer assembly separating said first and second glass panels, and wherein said variable friction device location is selected from at least one of said tilt barrel, said follower, and said corner key.

6. The insulated glass assembly of claim 1 wherein said first amount of friction is selected to overcome a gravitational pull from said window covering and wherein said second amount of friction is selected to be substantially zero.

7. The insulated glass assembly of claim 1 wherein said variable friction device comprises a clutch bearing assembly that is free-rolling as it rotates in said first direction and locks as it rotates in said second direction.

8. A window covering assembly comprising:
a window covering;
a follower in communication with said window covering via a cord;
an operator magnetically coupled to said follower capable of operating said follower;
said cord defining a cord path from said window covering to said follower, said cord path comprising at least one change in direction;
a clutch assembly disposed along said cord path at said change in direction, wherein said clutch assembly is inactive as said window covering is raised allowing said cord to move freely around said clutch assembly, wherein said clutch assembly is active as said window covering is lowered, said cord is held in position on said clutch assembly creating an amount of friction.

9. The window covering assembly of claim 8 wherein said amount of friction is sufficient to overcome a gravitational pull of said window covering.

10. The insulated glass assembly of claim 8 further comprising an additional clutch assembly, wherein said cord is routed through said additional clutch assembly to provide additional friction.

11. The insulated glass assembly of claim 8 wherein said window covering is selected from at least one of a shade and a blind.

12. The insulated glass assembly of claim 8 wherein said clutch assembly comprises a clutch ratcheting wheel and paddle.

13. The insulated glass assembly of claim 12 wherein clutch assembly comprises a clutch bearing assembly, wherein said clutch bearing assembly is free-rolling as it rotates clockwise and locks as it rotates counter-clockwise.

16. An insulated glass assembly comprising:
a first and second glass panel separated by a spacer assembly including a plurality of corner keys;
a window covering positioned between said first and second glass panels;
an operator connected to said operator with a cord, capable of operating said window covering;
a clutch bearing assembly housed in one of said plurality of said corner keys, wherein said cord translates on said clutch bearing assembly when said clutch bearing assembly is inactive to create a first amount of friction and drags across said clutch bearing assembly when said clutch bearing assembly is active to create a second amount of friction, said clutch bearing assembly being activated depending on the direction of rotation, wherein said first amount of friction is less than said second amount of friction.

17. The insulated glass assembly of claim 16 further comprising an additional clutch, wherein said cord is routed through said additional clutch to provide said first amount of friction, said second amount of friction, or both.

18. The insulated glass assembly of claim 16 wherein said second amount of friction is selected to overcome a gravitational pull from said window covering.

19. The insulated glass assembly of claim 16 wherein said first amount of friction is substantially zero.

20. The insulated glass assembly of claim 16 wherein said window covering is selected from at least one of a shade and a blind.
